(19) United States
(12) Patent Application Publication
(10) Pub. No.: US 2006/0236036 A1
(43) Pub. Date: Oct. 19, 2006

(54) Method and apparatus for predictive scheduling of memory accesses based on reference locality

(76) Inventors: Michael Karl Gschwind, Chappaqua, NY (US); Jude A. Rivers, Cortlandt, NY (US); John-David Wellman, Hopewell Junction, NY (US); Victor Zyuban, Yorktown Heights, NY (US)

Correspondence Address: KEUSEY, TUTUNJIAN & BITETTO, P.C., 20 CROSSWAYS PARK NORTH, SUITE 210, WOOBURY, NY, 11797, US

(21) Appl. No.: 11/105,058

(22) Filed: Apr. 13, 2005

(51) Int. Cl. G06F 12/00

(52) U.S. Cl. 711/137

(57) ABSTRACT

There are provided methods and apparatus for accessing a memory array. A method for accessing a memory array includes the step of predicting whether at least two memory references can be satisfied by a single array access based on one of an instruction address, local instruction history and global instruction history.

### BACKGROUND

1. Technical Field

The invention generally relates to the scheduling of memory accesses and, more particularly, to a method and apparatus for predictive scheduling of memory accesses based on reference locality.

2. Description of the Related Art

Contemporary high-performance processor designs are increasingly dominated by the constraints imposed by circuit technology. For example, the increase of wire delay relative to cycle time, resulting from lower FO4 designs and wire delays not scaling well in process technologies with small feature sizes (as have been deployed in the recent past and are predicted for the next generations), has forced the adoption of a replay-based pipeline control as disclosed in U.S. Pat. No. 6,192,466 (hereinafter the “'466 Patent”), entitled “Pipeline Control Mechanism for High-Frequency Pipelined Designs”, issued Feb. 20, 2001, the disclosure of which is incorporated by reference herein, and is commonly assigned to the assignee herein.

At the same time, future process technologies promise to complicate and eventually break the scaling of traditional 6T SRAM cell memory arrays.

As technology scaling becomes increasingly difficult, several new issues have become important. These issues affect not only the logic and circuit design, but also have an impact on the micro architecture. It is well known that process technology is not scaling uniformly. That is, some technology aspects are scaling better than others. For example, the interconnects (wires) are not scaling as well as the logic gates. A second, and somewhat newer concern is that for current and future device sizes, the presence or absence of a few atoms in a deposition layer can make a significant difference in terms of the gate performance. This means that the manufacturing variability across the chip is becoming increasingly significant, particularly for circuits where carefully tuned or balanced devices are required.

The technology scaling issues outlined above impact 6T cell Static Random Access Memories (SRAMs) in at least two significant ways. For example, non-uniform scaling increases the wire delays relative to the logic speed (among other effects). This can have a significant impact on the time it takes to access an SRAM cell within an array, as both word and bit lines represent a significant portion of the array access time. As another example, increased manufacturing variability makes it impossible to build minimally sized 6T SRAM cells at very high frequencies. Since the 6T SRAM cell relies on balanced (or matched) devices to reliably hold data, the minimally sized 6T cell, at current and near-future scales, requires fabrication depositions that are potentially accurate to the same number of atoms in a layer. This is currently beyond the capabilities of large-scale production fabrication processes.

Since random dopant fluctuations make the manufacturing of reliable, minimally sized 6T SRAM cells in near-future technology extremely difficult, a number of solutions have been considered. One option is to increase the size of the matched transistors used for building the basic 6T SRAM cell, which increases the number of atoms in the device layers, and thereby reduces the impact of slight variations in the deposition during the manufacturing process. Another option is to use a slower clock rate, or a more stable cell design (e.g., a cell design using more than six transistors per memory cell).

Note that both the impact of the different scaling rate for wires, and the increased impact of manufacturing variability serve to reduce the effective frequency at which an SRAM memory array can be accessed. These effects point towards a likely increase in the time needed to access the SRAM array relative to the processor clock rate, very possibly to the point where the array access time will exceed the processor clock rate and, thus, the latency of a single pipeline stage delay.

With regard to maintaining overall processor cycle time, one possible solution from a cache array design perspective involves allocating the equivalent of two pipeline stage delays (i.e., two processor cycles) to the SRAM array access. This will reduce the array access throughput to one access every other cycle, as the actual array access will be non-pipelined.

Further regarding maintaining the overall processor cycle time, the SRAM array may be organized as a large collection of small sub-arrays, each of which can be accessed in one cycle, and a selection is made from the outputs of these many sub-arrays using pipelined multiplexing logic. This solution will recover fully-pipelined access to the SRAM array, but will reduce the array density, as each sub-array will need to duplicate some logic, including address decoding logic, drivers, and sense amps, and the overall array will include additional routing and multiplexing logic, plus any pipeline registers within the pipelined multiplexor logic. This density reduction may in turn force longer wiring, requiring even deeper pipelining to overcome that additional delay. For a given area budget, this will also reduce the size of the memory that can be supported.

Either solution can degrade the performance of some workloads. For example, a number of latency-sensitive applications, such as programs represented by the SPECint2000 benchmark suite, transaction processing, and some desktop applications show a significant degradation with increased cache latency. Conversely, throughput-oriented workloads, such as SPECfp2000 workloads, show significant performance degradation when memory access bandwidth is reduced. The data demonstrates that the TPC-C benchmark is much more latency sensitive, which is understandable from the frequent often exposed dependence chains that would be directly impacted by the increased latency of the fully pipelined array. In contrast, the SPECcpu2000 program binaries exhibit more parallelism, often having independent memory operations scheduled back-to-back, and longer load-to-use distances to take advantage of the increased throughput and more robust performance in the face of increased cache access latencies.

Turning to FIG. 1, a high-performance high-frequency microprocessor is indicated generally by the reference numeral 100. The microprocessor 100 is described in the-above referenced '466 Patent.

The microprocessor 100 includes an instruction address stage (IA) 105, an instruction cache (I cache) 110, an instruction issue queue 115, and a prediction module 120. The microprocessor 100 also includes three distinct pipelines, namely, a load/store unit 125, a fixed-point unit 130, and a branch unit 135.

It is to be appreciated that the instruction address maintained in the instruction address stage 105 is also known as a program counter (PC) to those of ordinary skill in this and related arts. Moreover, it is to be appreciated that the words “microprocessor” and “processor” are used interchangeably herein.

In the microprocessor 100, instructions are fetched from the instruction cache 110 in response to the instruction address 105. The delay through the instruction cache 110 from the initial access to data availability varies in accordance with the instruction cache size and cache organization. In some implementations, an instruction cache may be implemented as a trace cache, as described, e.g., in U.S. Pat. No. 5,381,533, entitled “Dynamic Flow Instruction Cache Memory Organized Around Trace Segments Independent of Virtual Address Line”, issued on Jan. 10, 1995, the disclosure of which is incorporated by reference herein.

Instructions received from the instruction cache 110 are analyzed by branch prediction logic and re-steering of instruction fetch is performed in accordance with branch predictors and/or analysis of the instruction stream performed by the branch predictor. Instructions are issued in-order from the instruction issue queue 115 by instruction issue logic (not shown) attached thereto.

The load/store unit 125 includes a single register file (RF) access stage (optionally including bypass of results), and five execution stages. In an exemplary implementation, the five execution stages optionally include an address generation phase, an address translation phases, data access phases and data formatting phases. These execution stages are typically distributed across multiple cycles, and do not correspond closely to reference numerals/characters typically given to the specific stages shown in block diagrams such as, e.g., in FIG. 1. When a cache miss occurs, additional phases are required to perform cache reload from a next level in the memory hierarchy, as well as additional optional bypassing. When a result his been retrieved from the memory hierarchy and properly formatted (including alignment and sign/zero-extension, as well as any other data format conversions dictated by the instruction set architecture), the data is committed to the architected state in the write back (WB) phase.

The fixed-point unit 130 has a single register file (RF) access stage (optionally including bypass of results), and a single ALU execution stage. In a preferred embodiment, no register renaming is performed, and data are staged until the commit point in bypass stages. These bypass stages are optionally used to provide data to dependent instructions via a bypass network, without being committed to the architected register file. After an instruction has passed the commit point, the instruction is written back to the architected register file.

The branch unit 135 has a single register file (RF) access stage (optionally including bypass of results), and two branch execution stages. When an instruction is executed, and a branch misprediction is detected, the branch unit 135 updates the instruction address register used to perform instruction fetch, and signals a branch misprediction.

Branch mispredictions are handled by flushing all instructions following the incorrectly predicted branch from the processor pipeline, and restarting execution at the correct next instruction address.

In the microprocessor 100, no register values have to be restored from a history file, and no register maps need to be recovered, as all microprocessor pipelines buffer (and optionally provide for bypass) results until a common commit point. The common commit point is the last point in the pipeline wherein the execution of any instruction could trigger a flush of instructions to prevent committing of incorrect results, plus any signaling delay to indicate this condition to units which are to execute a flush cycle.

Hazards and exceptions are handled similarly. Thus, when an instruction has been speculatively issued to receive a result from a load operation in progress, and the load misses in the cache, a flush will be indicated and the instruction violating the dependence constraint due to late arrival of a result, as well as all successor instructions, are re-executed. Similarly, when an instruction raises an exception, e.g., a load or store instruction accessing an illegal address, or a floating point instruction executing in a floating point unit (not shown in FIG. 1) indicating an exception in accordance with the floating point architecture (such as the occurrence of overflow, underflow, divide by zero, and so forth), are executed similarly.

In accordance with this embodiment, instructions that are to be re-executed can be either re-fetched from the cache by resetting the instruction address driving cache access, or from buffers, such as buffers implementing a re-issue queue.

Modern high frequency microprocessor implementations use a replay-based mechanism based on schemes such as those described in the above-referenced '466 Patent, to avoid the cycle time impact of distributing global branch mispredict, stall and exception signals which have to be otherwise budgeted into the achievable cycle time.

While this decision is advantageous for cycle time, it can lead to clock per instruction (CPI) degradation, as potentially one or more stall cycles can be transformed into a significant penalty for re-fetching and re-executing an instruction stream, a penalty involving potentially 10-20 cycles for each occurrence. Thus, it is desirable to minimize the occurrence of situations forcing the performance of flush operations because instructions have violated dependence constraints.

Turning to FIG. 2, a superpipelined high-performance ultra-high frequency microprocessor is indicated generally by the reference numeral 200. The microprocessor 200 is described in the above-referenced '466 Patent.

The microprocessor 200 includes a steering stage 202 (for steering the instruction address), an instruction address stage (IA) 205, an instruction cache (I cache) 210, an instruction issue queue 215, and a prediction module 219 that includes one or more pipeline stages 220 and 222. The microprocessor 200 also includes three distinct pipelines, namely, a load/store unit 225, a fixed-point unit 230, and a branch unit 235.

The microprocessor 200 of FIG. 2 is based on the microprocessor 100 of FIG. 1, but differs there from in that the microprocessor 200 of FIG. 2 superpipelines the processor stages. That is, FIG. 2 shows that most execution phases have been further pipelined into at least two pipeline stages, giving a potentially high performance for ultra high frequency microprocessors.

The microprocessor 200 is in a sense hypothetical, because it presumes no limitation on pipelining of units, and in particular of the data cache access. Unfortunately, in accordance with the technology projections outlined previously, limitations on SRAM circuit scaling for the SRAM array used in an exemplary level 1 cache in the load/store unit of FIG. 2 limits such perfect scaling.

In one possible implementation, the pipeline has to be made even deeper, adding additional pipeline stages to the cache access to account for reduced memory density and increased signaling delay through a less dense cache, further pushing out the commit point. This has negative implications on processor performance and power, as additional bypass stages have to be inserted in other units (increasing area and power consumption), bypass networks have to be enlarged (thereby slowing down their speed of operation and/or causing them to dissipate more power), designs are made more complex, and CPI is degraded by increasing the likelihood and latency of flush cycles.

Turning to FIG. 3, a cache array architecture is indicated generally by the reference numeral 300. The architecture 300 includes an address decoder 310, a cache data array 320, a first selector circuit 330, a line buffer 340, a second selector circuit 350, an address module 360, and a delay module 370. It is to be appreciated that the first selector circuit 330 and the second selector circuit 350 each include one or more multiplexors.

The cache 300 receives an address from the microprocessor and the address is decoded by the address decoder 310. The address can either be a single address value, or two or more address components to be added or otherwise combined in accordance with the instruction set architecture specification to form the actual address. A subset of address bits is used to select a congruence class, and a line is selected from the congruence class by the first selector circuit 330 in accordance with tag match and hit/miss detection logic (not shown). In some cache implementations, this selection is implemented by sharing a single sense amplifier between the i^{th} bit of several congruence classes to select bit i of the selected congruence class as indicated by the tag match logic. The result is stored in the line buffer 340 (such as latches coupled to the sense amplifiers), and the required data are selected and formatted by the second selector circuit 350 selecting the requested bytes from the line (also known as column in data arrays) that has been retrieved from the memory array. The requested bytes are selected based on address bits (and optionally other control information) provided by the microprocessor, and returned to the microprocessor.

A variety of implementations are possible to implement a line buffer, i.e., a device for storing a line or subline retrieved from a cache. In one embodiment, the line buffer can be implemented as a latch with data hold functionality (either through a feedback multiplexor or by clock gating), or as a register. In a preferred embodiment, the line buffer can be coupled to the sense amplifier (by making the sense amplifier hold the data read out of the memory for multiple cycles). In yet another embodiment, it can be coupled to any pipeline latch on the path from the cache. It is to be appreciated that, given the teachings of the present invention provided herein, other implementations of a buffer for storing a line or subline will be readily apparent to those skilled in the art, while maintaining the scope of the present invention.

Turning to FIG. 4, a memory array is indicated generally by the reference numeral 400.

The memory array 400 includes a row decoder 410, a column selector and input/output circuits 420, and a random access memory (RAM) cell array 430.

A row of memory is accessed by the row decoder 410 based on a specified row address, and provided to the column selector 420. The column selector 420 will include storage elements for storing an accessed row. The column selector 420 then selects one or more bits from the row that has been accessed.

Turning to FIG. 5, a superpipelined ultra-high-frequency microprocessor in accordance with the microprocessor of FIG. 2 is indicated generally by the reference numeral 500.

The microprocessor 500 includes a steering stage 502 (for steering the instruction address), an instruction address stage (IA) 505, an instruction cache (I cache) 510, an instruction issue queue 515, a prediction module 519 that includes one or more pipeline stages 520 and 522, and a cache 524. The microprocessor 500 also includes a load/store unit 525, a fixed-point unit 530, and a branch unit 535.

It is to be appreciated that in FIG. 5, the cache 223 has not been superpipelined due to limitations in manufacturing technology. Thus, the cache 523 is shown separately from the load-store unit 525. This limits the throughput of cache access operations to half the rate of instructions that can be processed by the microprocessor. Thus, in accordance with this embodiment, a microprocessor can only schedule an instruction requiring a cache access every other cycle. This is specifically a limitation on instructions read-accessing the cache, as write accesses can be decoupled by a store buffer, to decouple the issuance of store instructions from the issue queue from the performance of cache write-accesses. Thus, this embodiment degrades processor performance by limiting the ability to issue load operations in back-to-back cycles, and further delaying the execution of dependent and successor instructions in the processor pipeline.

Turning to FIG. 6A, programming code having high locality of reference is indicated generally by the reference numeral 600. That is, FIG. 6A shows a burst access to memory. Such burst-access behavior is not uncommon in applications, including accesses to different fields in the same data structure, function call and return, function epilogues, block copy, and unrolled loops. The burst pattern shown in FIG. 6A corresponds to a function return (function epilogue), and shows another characteristic of many such burst accesses, namely the access to successive or otherwise closely correlated data. Advantageously, the present invention is capable of exploiting such spatial and temporal locality.

Thus, it would be desirable and highly advantageous to have a method and apparatus for predictive scheduling of instructions based on reference locality that overcomes the above-identified problems of the prior art.

### SUMMARY

The present invention is directed to a method and apparatus for predictive scheduling of instructions based on reference locality.

According to an aspect of the present invention, there is provided a method for accessing a memory array. The method includes the step of predicting whether at least two memory references can be satisfied by a single array access based on one of an instruction address, local instruction history and global instruction history.

According to another aspect of the present invention, there is provided an apparatus for accessing a memory array. The apparatus includes a prediction device for predicting whether two memory references can be satisfied by a single array access based on one of an instruction address, local instruction history and global instruction history.

According to yet another aspect of the present invention, there is provided a method for accessing a memory array. The method includes the step of predicting whether a Row Access Select (RAS) access can be bypassed and only a Column Access Select (CAS) access performed for a fetched instruction, based on a predictor. The method further includes the step of performing predictive instruction scheduling based on a result of said predicting step.

These and other objects, features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram of a high performance high frequency microprocessor, in accordance with the prior art;

FIG. 2 is a block diagram of a superpipelined high performance ultra-high frequency microprocessor, in accordance with the prior art;

FIG. 3 shows fundamental elements of a cache architecture, in accordance with the prior art;

FIG. 4 shows a memory array with row and column select as used in memory systems, in accordance with prior art;

FIG. 5 shows a block diagram of a superpipelined high performance ultra-high frequency microprocessor, in accordance with the prior art;

FIG. 6A shows programming code having high locality of reference, in accordance with the prior art;

FIG. 6B shows an exemplary method for speculatively issuing instructions for merged access;

FIG. 7 shows an exemplary method for performing a merge of memory operations to the same cache line in a microprocessor, in accordance with an illustrative embodiment of the present invention;

FIG. 8 shows an exemplary same line access merge (SLAM) unit executing the method steps performed by function blocks 710, 715, and optionally 720 in FIG. 7, in accordance with an illustrative embodiment of the present invention;

FIG. 9 shows an exemplary method for predicting the need to perform a row/column access, or a column access only, in accordance with a preferred embodiment of the present invention;

FIG. 10 shows an exemplary method for predicting the need to perform a row/column access, or a column access only, used for implementing predictive scheduling decisions of memory operations, in accordance with a preferred embodiment of the present invention;

FIG. 11 shows an exemplary predictor operating in accordance with the methods of FIGS. 9 and 10, integrated in a microprocessor pipeline as shown in FIG. 5, in accordance with an illustrative embodiment of the present invention;

FIG. 12 shows an exemplary cache array equipped to perform the method steps of function block 925, 930, 940, 945 of FIG. 9 or function block 1025, 1030, 1040, and 1045 of FIG. 10, in accordance with an illustrative embodiment of the present invention;

FIG. 13 shows exemplary predictor update logic operatively coupled to the prediction correctness check logic of FIG. 12, in accordance with an illustrative embodiment of the present invention; and

FIG. 14 shows exemplary operation of an asymmetric predictor, in accordance with a preferred embodiment of the present invention.

### DETAILED DESCRIPTION OF PREFERRED EMBODIMENTS

The present invention is directed to a method and apparatus for predictive scheduling of instructions based on reference locality.

Advantageously, the present invention provides a method and apparatus to: (1) exploit fine grain memory reference locality; (2) allow data reuse to data retrieved by a single row access from a cache; (3) offer a method to exploit data retention in sense amp latches; and (4) predictively issue instructions to take advantage of these opportunities when the opportunities exist, while avoiding over-aggressive instruction issue and dispatch when such opportunities are not present.

Advantageously, the present invention performs efficient high throughput cache accesses with minimal latency. Moreover, the present invention advantageously exploits program behavior to offer high throughput minimum latency access to data residing in the memory hierarchy and specifically the L1 cache. Further, the present invention advantageously minimizes both cycle time and CPI degradation to achieve maximum performance.

The present description illustrates the principles of the invention. It will thus be appreciated that those skilled in the art will be able to devise various arrangements that, although not explicitly described or shown herein, embody the principles of the invention and are included within its spirit and scope. In particular, while the illustrative preferred embodiment uses cache arrays to illustrate the advantages of the present invention, this invention can be applied to predict data locality based on instruction addresses for any type of memory access.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

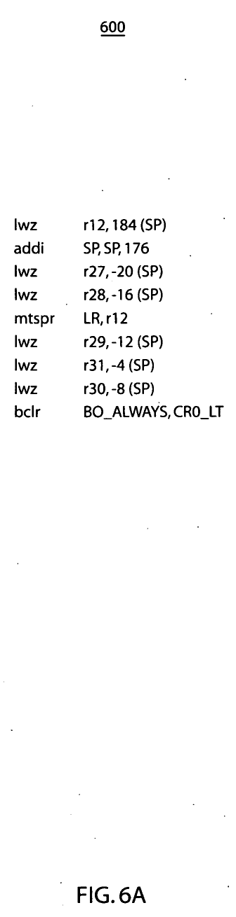

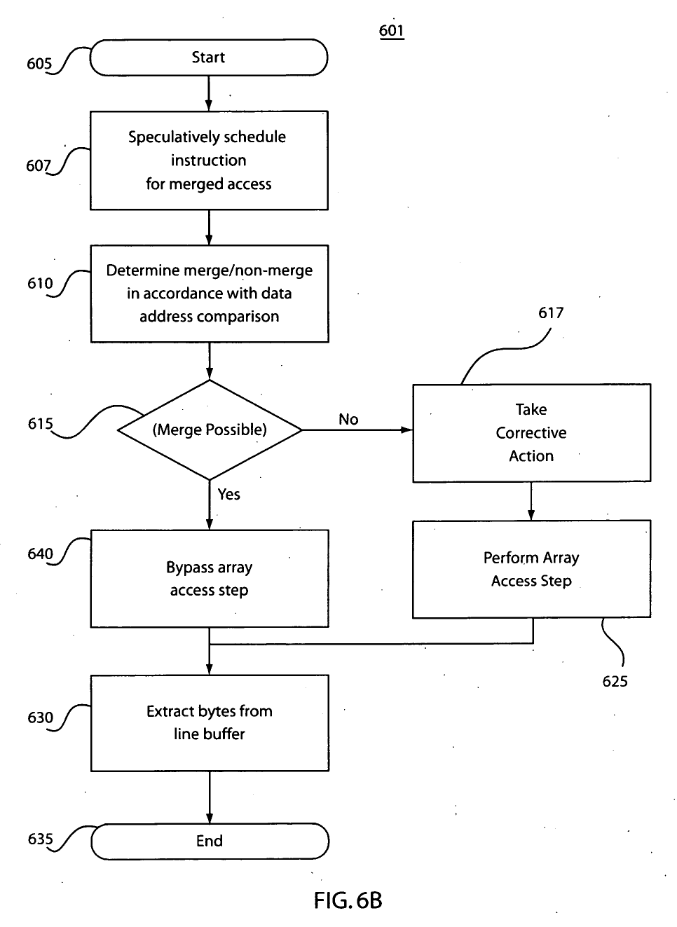

Turning to FIG. 6B, a method for exploiting spatial locality in burst memory accesses is indicated generally by the reference numeral 601.

A start box 605 passes control to a function block 607. The function block 607 speculatively schedules a memory instruction for merged access (e.g., by performing an issue or dispatch step), and passes control to a function block 610. The function block 610 determines whether a merged access (i.e., performing only a column access to extract bytes from a line buffer) is possible or a non-merged access (i.e., performing separate row and column accesses to retrieve the cache line from the cache array and extract the desired bytes) is necessary based on a result of a data address comparison that determines whether or not the data addresses of memory accesses refer to the same cache line, and passes control to a decision block 615. It is to be noted that if the data addresses of the memory accesses refer to the same cache line, then an indication is provided that the accesses to the row can be merged (i.e., a merged access can be performed). The decision block 615 determines whether or not the indication to perform a merged access was provided (i.e., if a merged access is possible). If the indication to perform a merged access was not provided, then control is passed to a function block 617. Otherwise, if the indication to perform a merged access was provided, then control is passed to a function block 640.

The function block 617 takes corrective action, and passes control to a function block 625. With respect to function block 617, the corrective action may include, but is not limited to, inserting a stall or flush cycle. The function block 625 performs an array row access step by retrieving a cache line from the cache array and storing the cache line in a line buffer, and passes control to a function block 630.

The function block 630 extracts one or more bytes from a line buffer and returns the bytes to the microprocessor to satisfy the load request, and passes control to an end block 635.

The function block 640 bypasses array access, and passes control to function block 630.

In accordance with the present invention, the method of FIG. 6 is executed in a microprocessor to increase the number of “virtual” ports to a memory structure in conjunction with simultaneously scheduling load operations exceeding the number of ports in a microprocessor. This method can be executed either by performing-simultaneous loads in a single ported fully pipelined cache, or two load requests in a not completely pipelined cache array at a rate higher than the initiation rate of the cache (i.e., when a cache can accept a new read request every n cycles, but load requests are scheduled every m cycles, and m<n), or both.

Unfortunately, while this method is advantageous in achieving higher throughput for memory operations, function block 617 can be implemented only with a high penalty (typically by flushing an instruction which should be stalled at the cost of typically 10 or more penalty cycles), leading to unacceptable CPI degradation. CPI is a metric for microarchitectural performs and expresses the average number of processor clock cycles necessary to execute an instruction.

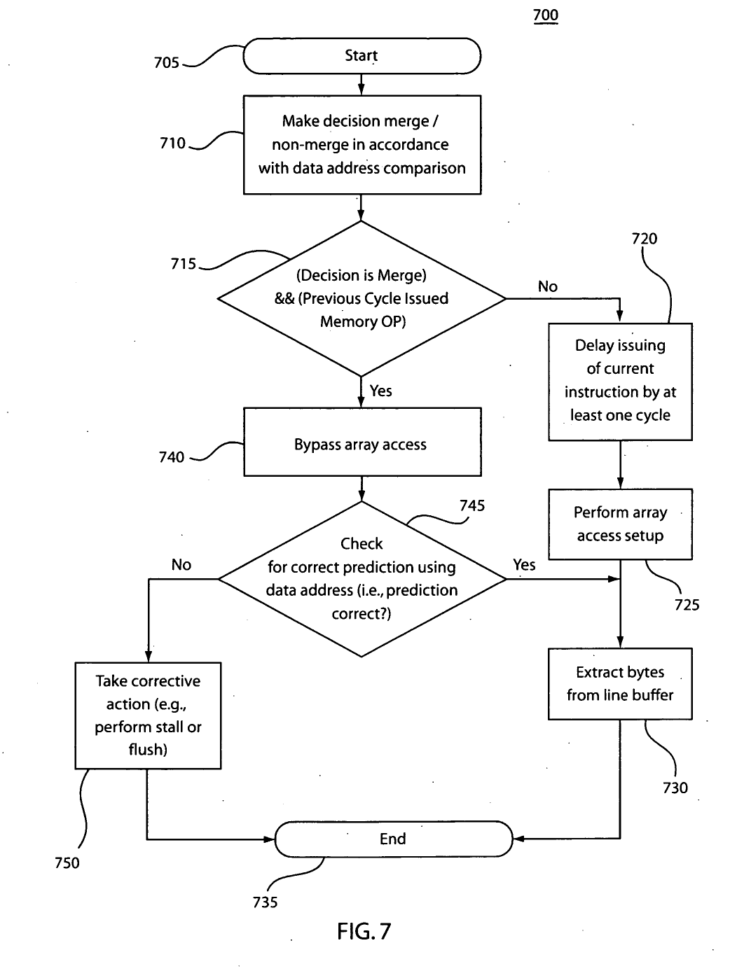

Turning to FIG. 7, a method for exploiting spatial locality in burst memory accesses is indicated generally by the reference numeral 700.

A start box 705 passes control to a function block 710. The function block 710 makes a decision to perform a merged access (i.e., performing only a column access to extract bytes from a line buffer) or a non-merged access (i.e., performing separate row and column accesses to retrieve the cache line from the cache array and extract the desired bytes) based on a result of a data address comparison that determines whether or not the data addresses of memory accesses refer to the same cache line, and passes control to a decision block 715. It is to be noted that if the data addresses of the memory accesses refer to the same cache line, then an indication is provided that the accesses to the row can be merged (i.e., a merged access can be performed). The decision block 715 determines whether or not the indication to perform a merged access was provided and whether or not the previous cycle issued a memory operation. If the indication to perform a merged access was provided and the previous cycle issued a memory operation, then control is passed to a function block 740. Otherwise, if the indication to perform a merged access was not provided and/or the previous cycle did not issue a memory operation, then control is passed to a function block 720.

The function block 720 delays the issuing of the current instruction by at least one cycle, and passes control to a function block 725. That is, function block 720 separates the burst accesses by inserting at least one cycle to prevent access by two conflicting memory accesses to the same cache if necessary (i.e., if the instructions are scheduled to execute within a window in which such conflict may occur). The function block 725 performs an array row access step by retrieving a cache line from the cache array and storing the cache line in a line buffer, and passes control to a function block 730. The function block 730 extracts one or more bytes from a line buffer and returns the bytes to the microprocessor to satisfy the load request, and passes control to an end block 735.

The function block 740 bypasses array access, and passes control to a decision block 745. The decision block 745 checks whether or not the prediction is correct using the data address. If the prediction is correct, then control is passed to function block 730. Otherwise, if the prediction is incorrect, then control is passed to a function block 750. The function block 750 takes corrective action (e.g., perform a stall or flush), and passes control to end block 735. It should be noted that based on the comparison of data addresses, the decision made in 710 can rarely, if ever, be incorrect. Specifically, only intervening coherence actions may cause the decision to be incorrect. In one optimized embodiment, decision logic 710 is coupled to coherence logic to ensure that the decisions are always correct even in the presence of coherence actions. In such an embodiment, test 745 and step 750 can be omitted.

In accordance with the present invention, the method of FIG. 7 is executed in a microprocessor to increase the number of “virtual” ports to a memory structure in conjunction with simultaneously scheduling load operations exceeding the number of ports in a microprocessor. This method can be executed either by performing simultaneous loads in a single ported fully pipelined cache, or two load requests in a not completely pipelined cache array at a rate higher than the initiation rate of the cache (i.e., when a cache can accept a new read request every n cycles, but load requests are scheduled every m cycles, and m<n), or both.

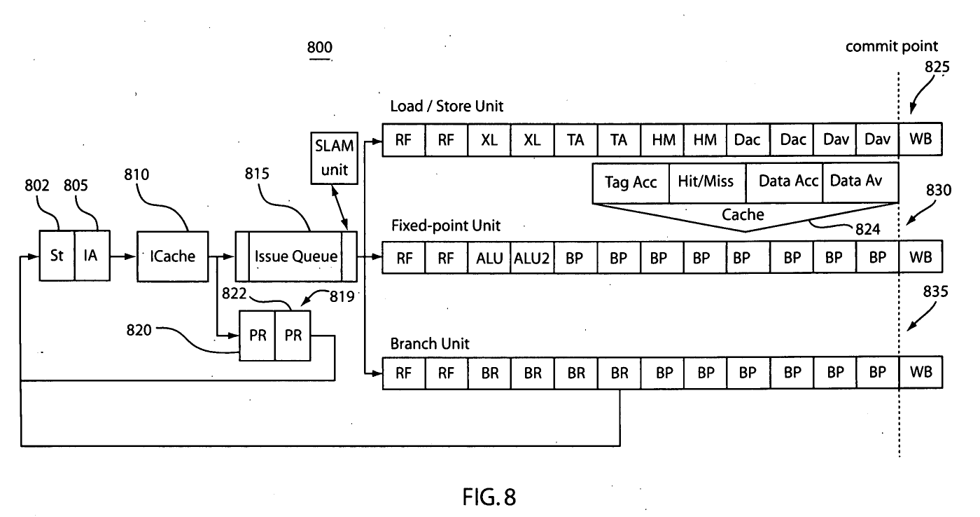

Turning to FIG. 8, a line access merge unit executing the method steps performed by function blocks 710, 715 and optionally 720 in FIG. 7 is indicated generally by the reference numeral 800.

The line access merge unit 800 includes a steering stage 802, an instruction address stage (IA) 805, an instruction cache (I cache) 810, an instruction issue queue 815, a prediction module 819 (that includes one or more pipeline stages 820 and 822), a cache 824, and a same line access merge (SLAM) unit 828. The microprocessor 800 also includes a load/store unit 825, a fixed-point unit 830, and a branch unit 835.

It is to be appreciated that in FIG. 8, the cache 823 has not been superpipelined due to limitations in manufacturing technology. Thus, the cache 823 is shown separately from the load-store unit 825.

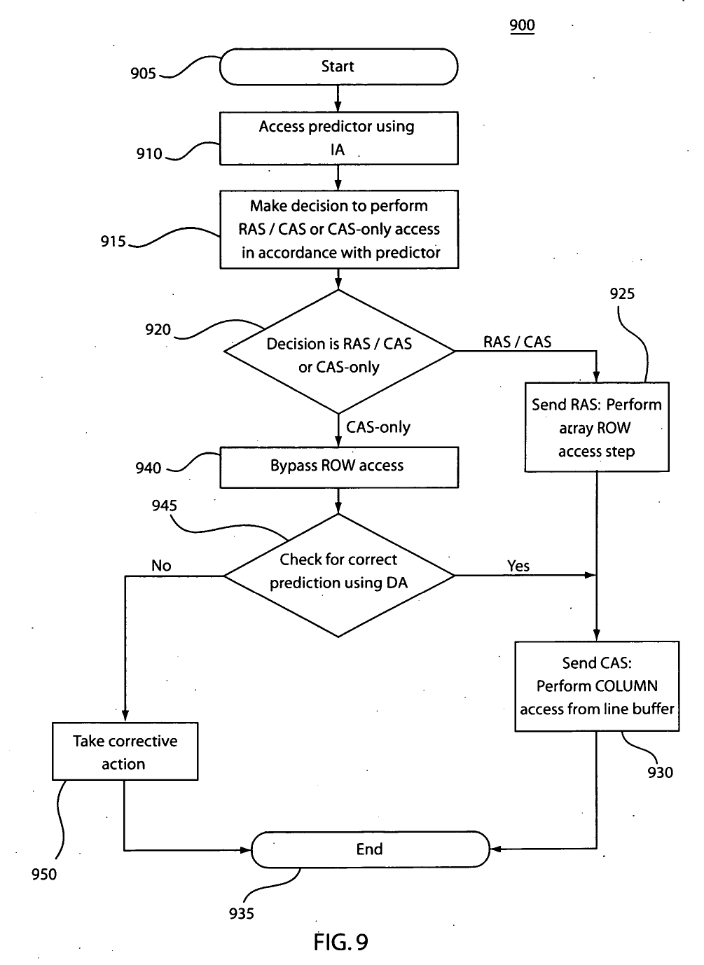

Turning to FIG. 9, a method for predicting the need to perform both a row (RAS) and column (CAS) access, or a column access only, is indicated generally by the reference numeral 900.

A start block 905 passes control to a function block 910. The function block 910 accesses a predictor using the instruction address of the instruction being fetched, and passes control to a function block 915. The function block 915 makes a decision to perform RAS/CAS or CAS-only access in accordance with the predictor state, and passes control to a decision block 920. It is to be appreciated that the predictor can be a 1-bit predictor, a 2-bit predictor, a local or global history predictor, or a tournament predictor in accordance with the prior art. The decision block 920 determines whether or not to perform RAS/CAS or CAS-only based on the decision made by the function block 915. If RAS/CAS is to be performed, then control is passed to a function block 925. Otherwise, if CAS-only is to be performed, then control is passed to a function block 940.

The function block 925 sends a Row Address Select (RAS) request to access a row in a memory and transfer it to a buffer, and passes control to a function block 930. The function block 930 sends a Column Address Select (CAS) request to access a subset of data specified by the CAS request from the line buffer, and passes control to an end block 935.

The function block 940 bypasses array access, and passes control to a decision block 945. The decision block 945 checks whether or not the prediction is correct by comparing the data address with a data address of a previous scheduled access to determine whether or not they refer to the same cache line. If the prediction is correct, then control is passed to function block 930. Otherwise, if the prediction is incorrect, then control is passed to a function block 950. The function block 950 takes corrective action, and passes control to end block 935. The corrective action that is taken by the function block 950 may optionally include, but is not limited to, updating the predictor used to make predictions, causing an instruction or operation sequence to be re-executed (e.g., by performing a flush cycle), re-executing the incorrectly predicted memory operation, transferring control to microcode for recovery, and so forth.

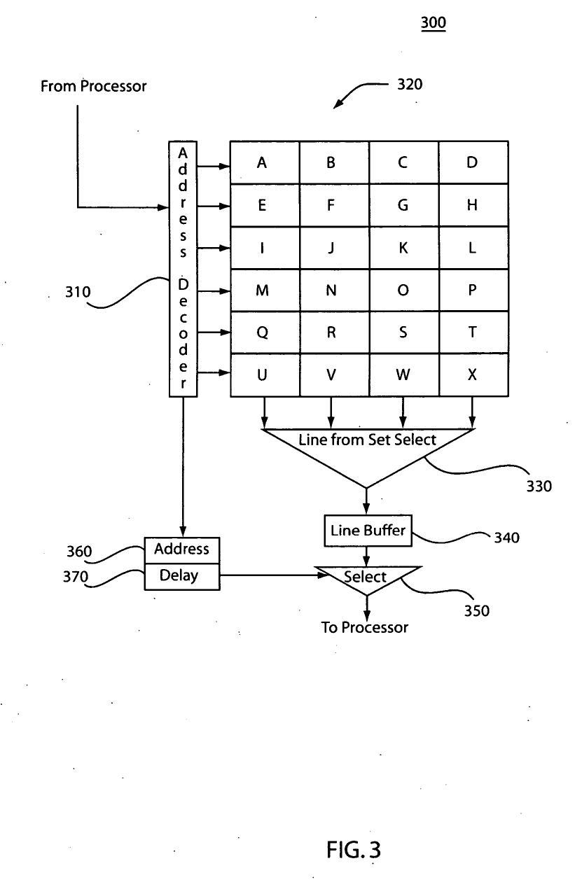

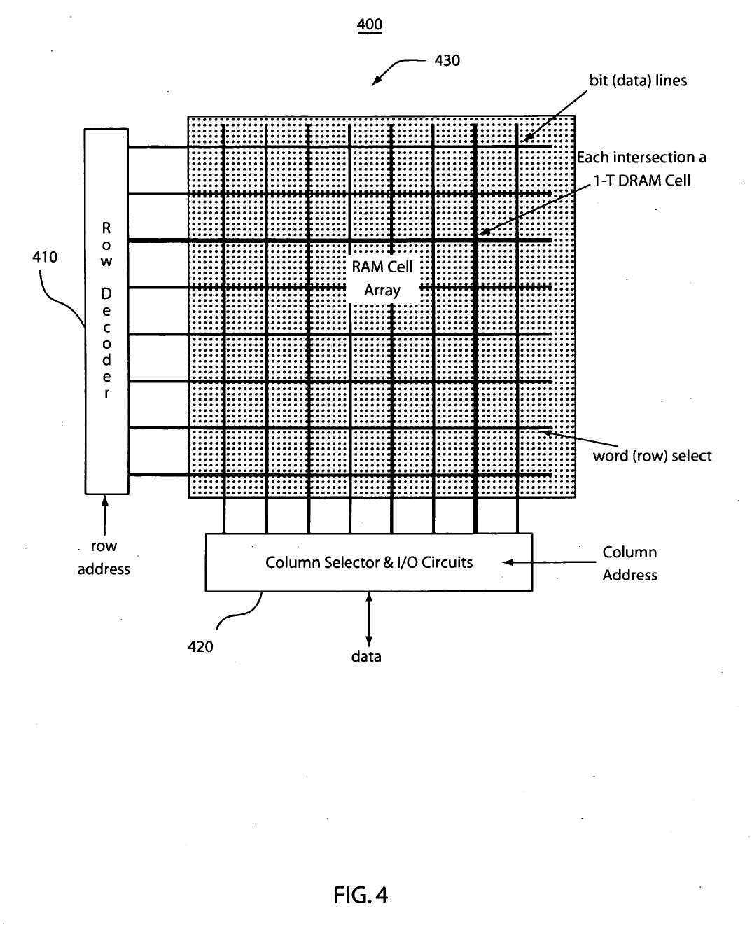

The method of FIG. 9 can be implemented in a variety of locations performing array accesses in a computer system. In one illustrative embodiment, it is used to optimize cache array accesses in accordance with the cache architecture shown in FIG. 3. In another aspect of the present invention, it is used to optimize accesses to other memory arrays as shown in FIG. 4, by predicting the necessity of performing RAS/CAS access sequences or CAS-only sequences based on the instruction address of the instruction (and/or optionally other history data used by a predictor), obviating the need to perform data address compares which may otherwise be necessary. In the prior art, data address comparison has been used to suppress row accesses in DRAM memory systems under the term of “page mode”. However, the prior art has neither used predictive techniques to determine whether two accesses may refer to the same row, nor used information about the need to perform row accesses to influence the instruction when instruction are fetched, dispatched, or issued. Instead, non-predictive address comparison has been used to reduce the delay in accessing a DRAM memory (or other such memory supporting a “page mode”) by eliminating a step (specifically the ROW access step) necessary in accessing a memory structure.

For the purposes of the present invention, the phrases “Row Access Select” (RAS) and “Column Access Select” (CAS) shall be interpreted broadly, with RAS access referring to any method for retrieving a line or subline from an array, and CAS access referring to any method for selecting one or more data bits from the line or subline.

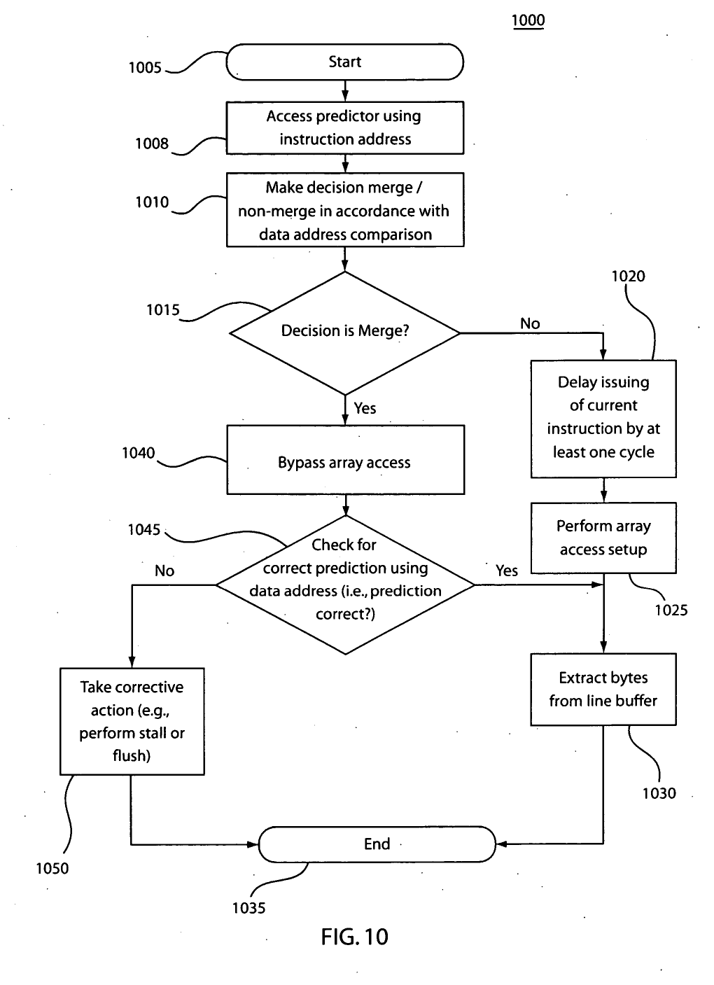

Turning to FIG. 10, a method for predicting the need to perform both a row (RAS) and column (CAS) access, or a column access only, and perform instruction fetch, dispatch or issue decisions based on such prediction, is indicated generally by the reference numeral 1000. The RAS and CAS access may need to be performed, e.g., when reading a cache line into a line buffer and selecting bytes there from. The CAS-only access may need to be performed, e.g., when selecting bytes from a line buffer that has been previously loaded by a load operation referencing the same cache line without reloading the line.

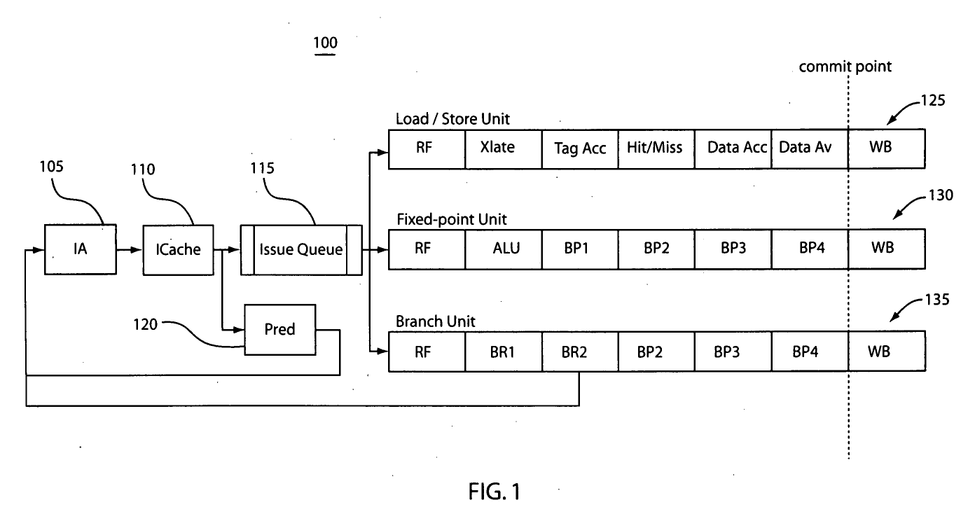

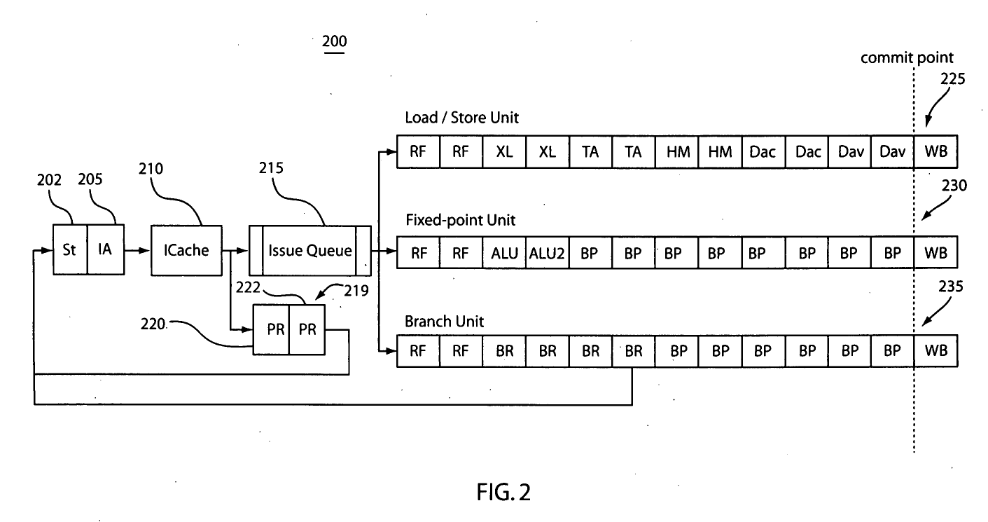

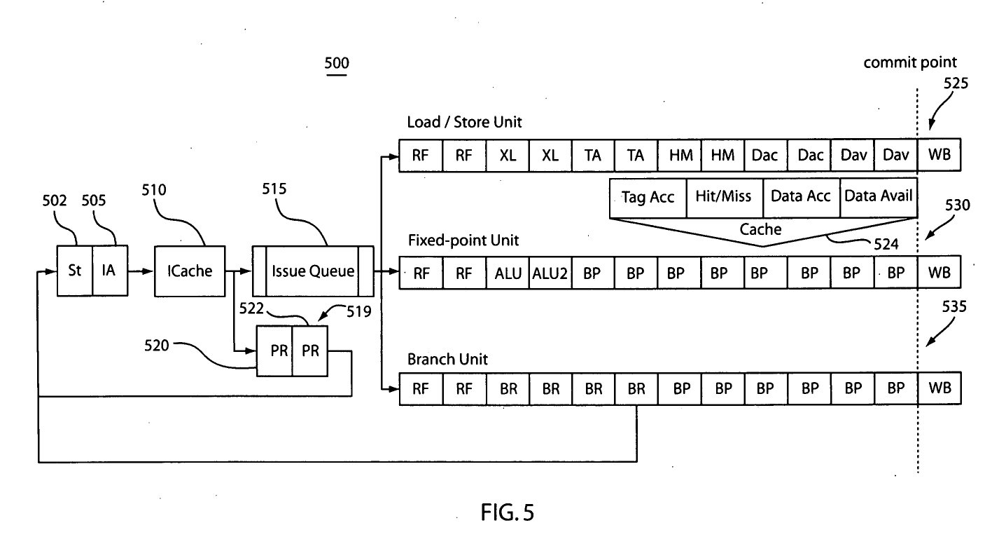

In a preferred embodiment, the method of FIG. 10 is performed by a microprocessor in accordance with FIGS. 1 and 2 (to concurrently provide two virtual ports to a fully pipelined cache with only one physical read port, or increase the number of ports from a first number of physical ports by exploiting such functionality to provide a second, greater number of virtual ports), or of FIG. 5 to allow fully pipelined access to a cache array when data access patterns permit in a microprocessor with a not fully pipelined cache, or both.

A start box 1005 passes control to a function block 1008. The function block 1008 accesses a predictor using the instruction address of the instruction being fetched, and passes control to a function block 1010. It is to be appreciated that the predictor can be a 1-bit predictor, a 2-bit predictor, a local or global history predictor, or a tournament predictor in accordance with the prior art. The function block 1010 makes a decision to perform a merged access (i.e., performing only a column access to extract bytes from a line buffer) or a non-merged access (i.e., performing separate row and column accesses to retrieve the cache line from the cache array and extract the desired bytes) based on the predictor, and passes control to a decision block 1015. The decision block 1015 determines whether or not an indication to perform a merged access was provided (by function block 1010). If the indication to perform a merged access was provided and the previous cycle issued a memory operation, then control is passed to a function block 1040. Otherwise, if the indication to perform a merged access was not provided and/or the previous cycle did not issue a memory operation, then control is passed to a function block 1020.

It is to be appreciated that in a preferred embodiment of the present invention, the function block 1015 also determines whether or not independent issue slots are available. If the independent issue slots are available, then an independent issue step is performed even when a merge is predicted to be possible to avoid the penalties of taking corrective action by function block 1045 (described herein below) when a misprediction might have occurred.

The function block 1020 delays the issuing of the current instruction by at least one cycle, and passes control to a function block 1025. In one optimized embodiment, step 1020 can be skipped if a physical array port is available in the present cycle.

The function block 1025 performs an array row access step by retrieving a cache line from the cache array and storing the cache line in a line buffer, and passes control to a function block 1030. The function block 1030 extracts one or more bytes from a line buffer and returns the bytes to the microprocessor to satisfy the load request, and passes control to an end block 1035.

The function block 1040 bypasses array access, and passes control to a decision block 1045. The decision block 1045 checks whether or not the prediction is correct using the data address. That is, the data address is compared with a data address of a previously scheduled access to determine if the compared data addresses refer to the same cache line. If the prediction is correct, then control is passes to function block 1030. Otherwise, if the prediction is incorrect, then control is passed to a function block 1050. The function block 1050 takes corrective action, and passes control to end block 1035.

It is to be appreciated that the corrective action taken by function block 1050 may optionally include, but is not limited to the following: the incorrectly merged instruction, as well as all successor instructions, are flushed and re-executed by either re-fetching these instructions from the instruction cache, or re-issuing them from buffers maintained in the microprocessor. In addition, the predictor array may be updated.

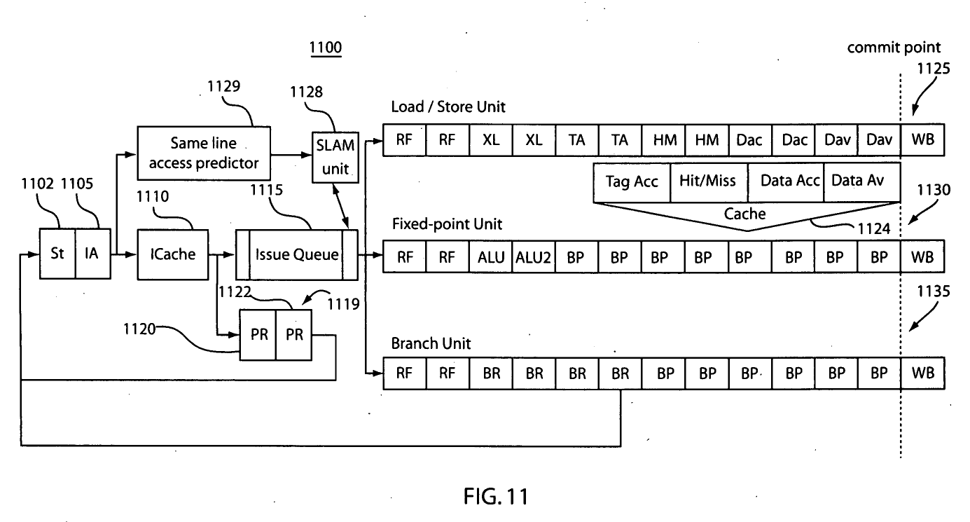

Turning to FIG. 11, a microprocessor is indicated generally by the reference numeral 1100. The microprocessor 1100 is based on the microprocessor shown and described with respect to FIG. 5, and is shown with respect to a predictor that is employed in accordance with the methods of FIGS. 9 and 10.

The microprocessor 1100 includes a steering stage 1102, an instruction address stage (IA) 1105, an instruction cache (I cache) 1110, an instruction issue queue 1115, a prediction module 1119 (that includes one or more pipeline stages 1120 and 1122), a cache 1124, a same line access merge (SLAM) unit 1128, and a same line access predictor 1129. The microprocessor 1100 also includes a load/store unit 1125, a fixed-point unit 1130, and a branch unit 1135.

It is to be appreciated that in FIG. 11, the cache 1123 has not been superpipelined due to limitations in manufacturing technology. Thus, the cache 1123 is shown separately from the load-store unit 1125.

In accordance with the preferred embodiment of FIG. 11, the same line access predictor 1129 is accessed with the instruction address (function block 910 of the method of FIG. 9, and function block 1008 of the method of FIG. 10) in parallel to the instruction cache access. Function block 915 and decision block 920 of the method of FIG. 9, or function blocks 1010 and 1015 of the method of FIG. 10 are implemented in the same line access merge (SLAM) unit 1128. The SLAM unit 1128 is operatively coupled to the instruction issue logic (not shown) that is enhanced to implement function block 1025.

Those skilled in the art will understand that the same line access predictor 1129 can also be accessed with local and/or global history information in alternate embodiments of the present invention.

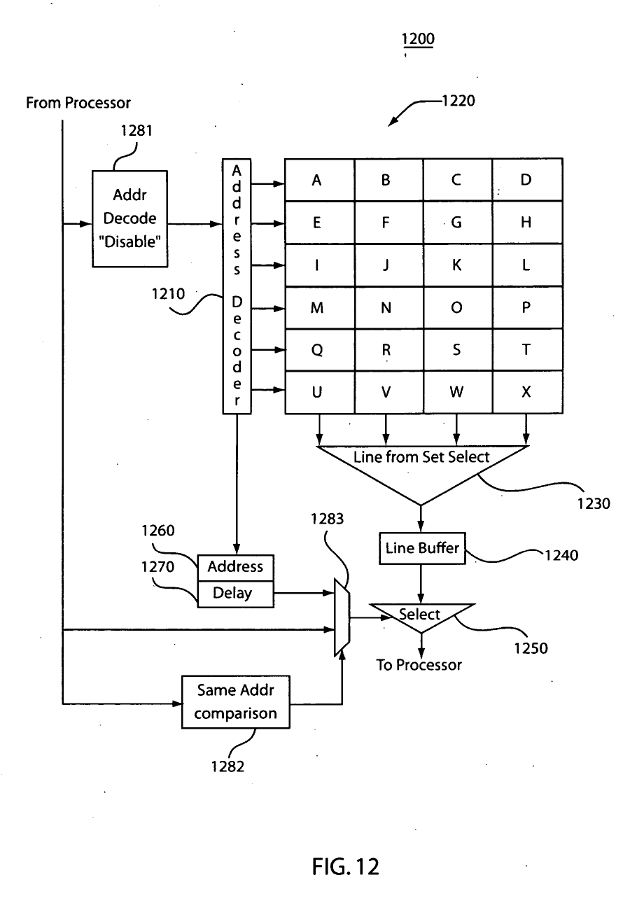

Turning to FIG. 12, an enhanced cache architecture is indicated generally by the reference numeral 1200. The cache architecture 1200 is enhanced, e.g., with respect to the prior art cache architecture 300 shown in FIG. 3, in being capable of executing either a cache array bypass step 1040 (by asserting an address decode disable signal) or a cache array access step 1025. The enhanced cache architecture 1200 may perform the method of FIG. 10.

The cache 1200 includes an address decoder 1210, a cache data array 1220, a first selector circuit 1230, a line buffer 1240, a second selector circuit 1250, an address module 1260, a delay module 1270, an address decoder disable unit 1281, same address comparison logic 1282, and a multiplexor 1283. It is to be appreciated that the first selector circuit 1230 and the second selector circuit 1250 each include one or more multiplexors.

The line buffer 1240 and the same address comparison logic 1282 are used by function block 1045 to check whether the prediction is correct.

The same address comparison logic 1282 is coupled with an indicator circuit (not shown) that tests whether an array access bypass was performed, and a subsequent address mismatch has been detected. If this is the case, then corrective action is initiated.

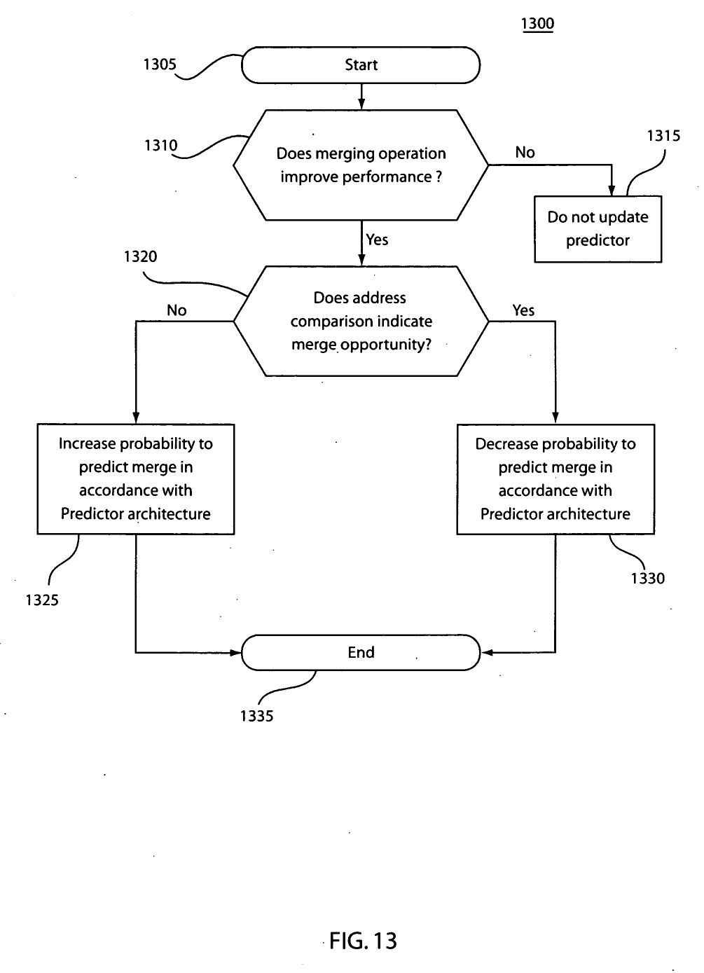

The same address comparison logic 1282 is also operatively coupled to a predictor update mechanism and/or method, e.g., the exemplary method of FIG. 13.

The second selector circuit 1250 is used to implement the functions performed by function block 1030 of FIG. 10.

In one embodiment, the line buffer is invalidated in response to a store instruction to enforce data consistency.

In at least one embodiment, the line buffer 1240 is connected in signal communication with coherence enforcing logic. In one embodiment, coherence enforcing logic invalidates the contents of line buffer 1240 whenever an instruction establishing an event ordering in the system is executed. In another embodiment, coherence logic in accordance with the prior art coherence logic is connected in signal communication with the line buffer to enforce data coherence between the cache array 1220 and the line buffer 1240. In yet another optimized embodiment, coherence is enforced by invalidating the line buffer after a predetermined number of cycles. In one exemplary method of this implementation, a line buffer can be accessed only by one instruction in a successive cycle, thereby preventing the establishment of an event ordering point between successive uses of a line buffer.

Turning to FIG. 13, a method for updating a predictor array is indicated generally by the reference numeral in accordance with the method of FIG. 13, a predictor is updated as a result of performing the checking step performed by function block 945 of FIG. 9, or the checking step performed by function block 1045 of FIG. 10. In another embodiment, a separate address comparison is performed to update the predictor in accordance with FIG. 13.

A start block 1305 passes control to a decision block 1310. The decision block 1310 determines if merging a load operation with a preceding load operation by suppressing an array access (i.e., by performing a CAS-only access in lieu of a RAS/CAS access) will be beneficial. If the merge will not be beneficial, then control is passed to a function block 1315. Otherwise, if the merge will be beneficial, then control is passed to a decision block 1320.

The function block 1315 suppresses an update to the predictor array, and passes control to an end block 1335.

The decision block 1320 determines if a merge opportunity was present. If the merge opportunity was not present, then control is passed to a function block 1325. Otherwise, if the merge opportunity was present, then control is passed to a function block 1330.

The function block 1325 updates the predictor array to increase the likelihood of predicting a merge opportunity in the future, and passes control to end block 1335.

The function block 1330 updates the predictor array to decrease the likelihood of predicting a merge opportunity in the future, and passes control to end block 1335.

The method of FIG. 13 for updating the predictor array suppresses predictor updates to the prediction array if step 1010 of the method of FIG. 10 identifies that merging two accesses is not beneficial. Preventing updates to a prediction array with predictions that are not beneficial preserves predictor space for those operations that benefit from good predictions, and reduces the potential of destructive aliasing occurring in a prediction array. In another embodiment, the functions performed by function block 1310 are not performed, and the method starts with the functions performed by function block 1320.

In an optimized embodiment of the methods of FIGS. 9 and 10, the prediction step uses a novel, improved predictor for use in prediction determination logic steps performed by function blocks 915 or 1020 in accordance with the present invention. While traditional predictors have offered hysteresis, such hysteresis logic has been symmetric in nature, offering similar amounts of hysteresis for both prediction opportunities. Thus, hysteresis predictors have offered 2k states, with k states predicting a positive result, and k states predicting a negative result.

In accordance with the present invention, an optimized asymmetric predictor has m states, wherein n states, for n<m/2 predict one outcome, and m−n states, m−n>m/2, predict the adverse outcome. In other words, the predictor has a higher probability (specifically, (m−n)/m) to predict a second outcome than predicting a first outcome (specifically, n/m).

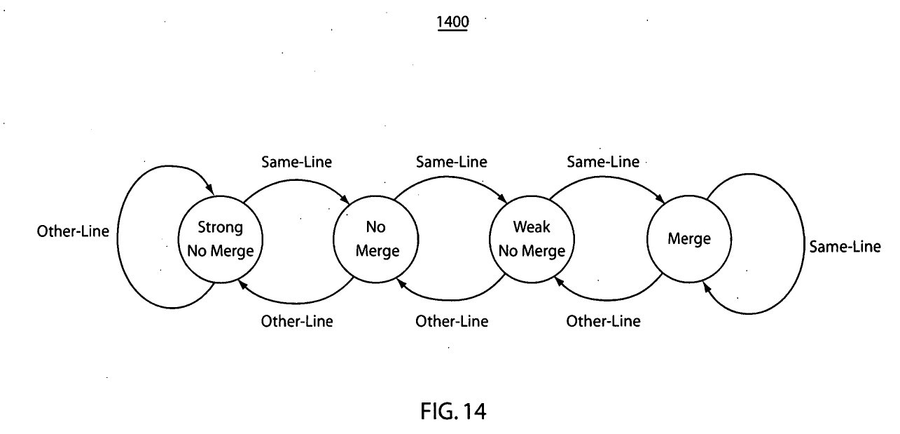

Turning to FIG. 14, an asymmetric predictor having four states is indicated generally by the reference numeral 1400. The asymmetric predictor 1400 has 4 states, 3 of which indicate varying degrees of an adverse outcome (interpreted as an indicator not to merge a load operation with a previous load operation by omitting a cache array access), and one state indicating a positive outcome. When the predictor is updated, a successful merge opportunity is used to increase the probability of a same line access by transitioning the state of the predictor entry to a state to the right. Conversely, the occurrence of a non-mergeable sequence weakens the probability of prediction. The predictor is skewed towards providing hysteresis against the merging opportunity, and no hysteresis at all in favor of merging. Asymmetric predictors as the one proposed herein offer significant advantages in situations where the potential for improvement in the case of one prediction is significantly asymmetric from the potential for degradation in the case of another prediction. The asymmetric predictor reflects this skewed cost/benefit ratio in its architecture and allows improvement in overall performance by adapting the predictor operation to the specific cost/benefit tradeoff inherent in each prediction.

In accordance with the present invention, the same line access merge functionality can be implemented in in-order and out-of-order microprocessors. Those skilled in the art will understand that in an out-of-order issue design, the issue logic can perform a re-ordering of loads based on the likelihood for successful merge operations, to increase the number of accesses that have been merged successfully.

Those skilled in the art will also understand that where the term “address” has been used, one of effective, virtual, real, physical, absolute or other such method for indicating and/or comparing addresses can be used. In particular, when comparing data addresses to determine successful access merging, an effective or virtual address might be used to reduce the amount of data translation necessary. Using the effective address to determine whether two accesses refer to the same line ignores the infrequent possibility of having two effective addresses on different pages refer to the same physical line, as this requires translation by the effective to real address table (e.g., ERAT, which is a merged segment and page table lookaside buffer in PowerPC implementations.) However, this is a conservative assumption, and allows recovery to be started several cycles earlier.

Depending on processor implementations, a microprocessor uses different methods to determine the order of instructions to be executed. These methods are generally known under the terms of “instruction dispatch” or “instruction issue”. Terminology for this instruction execution order determination step also varies between different practitioners. Both predictive instruction dispatch and predictive instruction issuance can be practiced in accordance with the present invention, and the phrases are intended to be used interchangeably for the purposes of the present invention.

These and other features and advantages of the invention may be readily ascertained by one of ordinary skill in the pertinent art based on the teachings herein. It is to be understood that the teachings of the invention may be implemented in various forms of hardware, software, firmware, special purpose processors, or combinations thereof.

Most preferably, the teachings of the present invention are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the invention is not limited to those precise embodiments, and that various changes and modifications may be effected therein by one of ordinary skill in the pertinent art without departing from the scope or spirit of the invention. All such changes and modifications are intended to be included within the scope of the invention as set forth in the appended claims.

What is claimed is:

1. A method for accessing a memory array, comprising the step of predicting whether at least two memory references can be satisfied by a single array access based on one of an instruction address, local instruction history and global instruction history.

2. The method according to claim 1, further comprising the step of performing instruction dispatch based on a result of said predicting step.

3. The method according to claim 1, wherein said predicting step utilizes an asymmetric predictor to render a prediction.

4. The method according to claim 1, further comprising the steps of bypassing a Row Access Select (RAS) and performing only a Column Access Select (CAS), when the at least two memory references are predicted by a predictor to be satisfiable by the single array access.

5. The method according to claim 4, further comprising the step of speculatively scheduling instructions based on the predictor in a same cycle or successive cycles.

6. The method according to claim 4, further comprising the steps of:
determining whether a prediction of the predictor is correct; and
taking corrective action, when the prediction is incorrect.

7. The method according to claim 1, further comprising the step of bypassing an array access when the at least two memory references are predicted to be satisfiable from a same array access and at least one of the at least two memory references is satisfied from a line buffer.

8. The method according to claim 7, wherein coherence is established between the line buffer and the memory array by invalidating the line buffer in response to one of a store instruction and a synchronizing instruction.

9. The method according to claim 7, wherein coherence is established between the line buffer and the memory array by invalidating the line buffer in response to a lapse of a predetermined number of cycles.

10. A program storage device readable by machine, tangibly embodying a program of instructions executable by the machine to perform method steps for predictive instruction dispatch as recited in claim 1.

11. An apparatus for accessing a memory array, comprising a prediction device for predicting whether at least two memory references can be satisfied by a single array access based on one of an instruction address, local instruction history and global instruction history.

12. The apparatus according to claim 11, further comprising means for performing instruction dispatch based on a result of said prediction device.

13. The apparatus according to claim 11, wherein said prediction device utilizes an asymmetric predictor to render a prediction.

14. The apparatus according to claim 11, further comprising means for bypassing a Row Access Select (RAS) and performing only a Column Access Select (CAS), when the at least two memory references are predicted by a predictor to be satisfiable by the single array access.

15. The apparatus according to claim 14, further comprising means for speculatively scheduling instructions based on the predictor in a same cycle or successive cycles.

16. The apparatus according to claim 14, further comprising:
means for determining whether a prediction of the predictor is correct; and
means for taking corrective action, when the prediction is incorrect.

17. The apparatus according to claim 11, further comprising means for bypassing an array access when the at least two memory references are predicted to be satisfiable from a same array access and at least one of the at least two memory references is satisfied from a line buffer.

18. The apparatus according to claim 17, further comprising means for establishing coherence between the line buffer and the memory array by invalidating the line buffer in response to one of a store instruction and a synchronizing instruction.

19. The apparatus according to claim 17, further comprising means for establishing coherence between the line buffer and the memory array by invalidating the line buffer in response to one of a store instruction and a synchronizing instruction.

20. A method for accessing a memory array, comprising the steps of:
predicting whether a Row Access Select (RAS) access can be bypassed and only a Column Access Select (CAS) access performed for a fetched instruction, based on a predictor; and
performing instruction scheduling based on a result of said predicting step.
